(19) United States
(12) Patent Application Publication
(10) Pub. No.: US 2021/0378218 A1
(43) Pub. Date: Dec. 9, 2021

(54) Beehive Feeding Device and Method

(71) Applicant: Spring Creek Honey LLC, Bellefonte, PA (US)

(72) Inventor: Joseph Riley, Bellefonte, PA (US)

(73) Assignee: Spring Creek Honey LLC, Bellefonte, PA (US)

(21) Appl. No.: 17/316,776

(22) Filed: May 11, 2021

Related U.S. Application Data
(60) Provisional application No. 63/035,053, filed on Jun. 5, 2020.

(51) Int. Cl. A01K 53/00; A01K 47/06

(52) U.S. Cl. CPC A01K 53/00; A01K 47/06

(57) ABSTRACT

A fondant feeding method and device for beekeeping. The method and apparatus comprising a raised platform having at least one through hole. The raised platform is placed atop the uppermost box in a standard hive body and fondant is placed above the through hole. Optional mesh within the through hole prevents the fondant from sagging. The platform and fondant are surrounded by an enclosing structure and topped with an inner and outer cover such that the device and food are housed within the hive body and protected from the elements. Bees may cluster freely beneath the chamber created by the raised platform to feed and generate heat. The platform shields the cluster from dripping condensation while simultaneously promoting a fondant consistency that is ideal for feeding.

### CROSS REFERENCE TO RELATED APPLICATIONS

This application claims benefit of priority from U.S. Provisional Patent Application No. 63/035,053 of Joseph Riley, filed Jun. 5, 2020, entitled Beehive Feeding Device and Method, the entirety of which is incorporated herein by reference.

### STATEMENT REGARDING FEDERALLY SPONSORED RESEARCH/DEVELOPMENT

Not Applicable

### PARTIES TO A JOINT RESEARCH AGREEMENT

Not Applicable

### REFERENCE TO SEQUENCE LISTING, TABLE OR COMPUTER PROGRAM

Not Applicable

### FIELD OF THE INVENTION

The present invention pertains to a device and method to help bee colonies successfully overwinter by offering a means of consistent food, shelter, and ventilation within the hive.

### BACKGROUND OF THE INVENTION

The Bee Informed Partnership is a nationally recognized collaboration of research labs and universities engaged in agricultural science. According to a report recently released by this organization and others like it, over 40 percent of bee colonies die each year. This loss has been attributed to a number of variables; however, the hive's inability to successfully overwinter is one of the main reasons for these casualties. Many hives lack a consistent source of food and may experience excessive moisture within the hive structure resulting in disease and loss within the colony.

For generations, man has constructed outdoor beehives both to harvest honey and to assist in the pollination of crops. A beehive generally includes one or more boxes filled with a plurality of suspended wooden frames. The wooden frames within each box provide a foundation on which bees can build combs to raise broods or store honey. In a typical beehive tower, a wooden inner cover is positioned directly above the frames such that there is very shallow spacing between the underside of that inner cover and the top of the frames. The inner cover fits snugly around the edges of the box at the uppermost position on the stack and may have notches to allow for the exchange of air. A wooden telescoping outer cover is placed over the inner cover to provide a protective lid against the elements.

Because the structure is kept outdoors, the temperature within the hive interior falls as the ambient exterior temperature decreases throughout the autumn and winter months. Bees form a plurality of substantially spherically shaped clusters in the narrow spaces between the frames to combat this temperature loss. The cool, outer surface of the cluster is tightly packed with bees while the interior is less dense, allowing bees in that area to move, using their flight muscles to generate heat. Individual members of the colony take turns rotating from the outer layer to the inner layer and back again to obtain food and warmth. The problem with this configuration is that the frames within the box body prevent lateral movement of the bees; each small cluster can therefore access only that honey stored within the proximate frames. The narrow spacing between the frames also limits the size and motion of the bee cluster. If a cluster is too dense to allow movement of individual bees or too small to produce sufficient warmth, the bees will die of either starvation or hypothermia.

Beekeepers have attempted to address this problem by providing supplemental food. One common method involves placing a sheet of paper on top of the frames and covering it with a small amount of fondant or sugar to provide an emergency food source for the bees. This method is typically referred to as the “mountain camp method.” The supplemental food is enclosed within a shallow space between the top of the frames and bottom of the inner cover as illustrated in FIG. 1.

There are a number of disadvantages to this method but the main drawback involves “wetting” of the bees. When fully assembled, the components within a beehive tower form a substantially closed structure as illustrated in FIG. 1. In cooler periods, bees will move their muscles to generate heat, creating a tower interior that is warmer than the air on the tower's exterior surfaces. As a result, the heat within the hive condenses on the cool bottom face of the inner cover and sides of the box, dripping water onto the cluster. This collection of moisture tends to freeze and thaw, collecting and dropping repeatedly on the bees as temperatures fluctuate. While a dry bee may be able to withstand cold temperatures, wet bees cannot survive. Once the core temperature of a bee falls below a certain threshold, it can no longer move to generate heat and will die. This becomes an even greater concern when the bees are sandwiched just below the shallow inner cover to feed on the fondant or sugar mound in the mountain camp method. The close proximity to the wet underside of the inner cover dampens the cluster and weakens the hive.

Another issue with the mountain camp method involves additional exposure of the hive to cold temperatures. The limited space between the inner cover and top of the frames allows for the placement of only a small amount of food which must be replenished frequently. Beekeepers must open the inner and outer covers repeatedly during the cool winter months to check the status of the food. Each time the covers are removed, the temperature of the hive is lowered and the cluster beneath the inner cover is exposed and displaced, further weakening the hive.

The quality of the bee food is also affected by the mountain camp method. All protective packaging must be removed to give the bees access to the entire surface area of the feed; this results in desiccation and hardening of the fondant or sugar. Within a short period of time, the food becomes tough, impenetrable, and nearly impossible for the bees to eat. So while there is a food source above the bees, they cannot take full advantage of it due to its consistency. The natural upward motion of each cluster with the rising heat prevents individual bees from retreating downward toward any remaining honey in the frames. The cluster remains huddled in the damp area between the frame tops and inner cover where bees often starve or die of exposure.

Rodents can also pose an issue when using supplemental feed, infiltrating the hive to feast on the sugary material. These pests will remain at the top of the frames where they urinate and defecate on the bees and honey below. This contaminates the honey and lowers the core temperature of any bees still clustering within the frames.

There is therefore a need in the art for a device and method for monitoring, sheltering, and consistently feeding bee colonies throughout the autumn and winter months. There is further a need for a device and method that allows the bees to cluster in a formation that maximizes warmth and minimizes humidity during these critical months.

### BRIEF DESCRIPTION OF THE INVENTION

For the purpose of this application, the term “fondant” shall refer to any suitable bee food of a generally solid or crystalline nature such as sugar cakes, sugar bricks, sugar mountains, and the like. The term “hive box” shall refer to hive bodies, supers, and other box-like structures added to the tower of a standard beehive stack. The term “box” should not be viewed as limiting the geometry to rectangular shapes as other hive tower shapes may be used, such as cylinders. The term “cardboard packaging” shall be used exclusively to refer to any paper or cardboard box or similar packaging surrounding the bee food.

The method and device of the present invention replaces the standard and problematic feeding technique described above by placing a raised feeding platform within an enclosing structure beneath the inner and outer covers. In the preferred embodiment, the platform is comprised of a substantially horizontal feed board elevated by two “feet” or elevating elements at opposing sides of the platform and open on the remaining opposing ends. The feet of the platform are in direct contact with the plurality of frame tops such that a void is created below the bottom surface of the platform face and the top of the frames. This void creates a warm and dry space for the bees to cluster and feed.

The platform has at least one through hole oriented substantially vertically through the horizontal face of the feed board. Ideally, this hole is centered within the horizontal face; however, the hole may be placed in other areas of the platform. Each through hole may be covered with or may have an integrated supportive structure such as a mesh material or hardware cloth capable of bearing up to fifty pounds of weight. The openings within the supportive structure are of a size that will allow individual bees to traverse through the material. The desired quantity of fondant is placed on top of the through hole, providing a consistent food source above the bees clustering in the void created by the platform. This block of food may be left in its original packaging such that the food is surrounded by its plastic covering. This covering helps the fondant retain a soft consistency and prevents undesirable animals and insects from feeding on the exterior surfaces of the fondant. The cardboard packaging may also be placed on top of the fondant, if desired, to absorb excess moisture and humidity dropping from the inner cover above.

The space between the frame tops and platform allows the bees to cluster in one large, compact formation in the center of the hive structure rather than numerous smaller clusters between the frames. This position and greater number of bees keeps the hive warmer and away from the cooler walls of the hive tower. The tightly packed nature of the cluster reduces air space between the bees and subsequently reduces the condensation within that cluster.

This design has numerous advantages. Because the bees have access to a substantial surface area of the fondant beneath the feeding hole, there is no need to expose the entire surface of the fondant to air within the upper box. As previously noted, the original outer packaging may remain on the exterior of the feed, preventing the fondant exterior from drying out. The exposed surface of the fondant at the through hole absorbs the moisture and warmth generated by the bees below it, creating an ideal feeding consistency for the bees.

The platform also provides shelter to the hive which is lacking in other known feed methods. The diameter of an average winter bee cluster is akin to that of a basketball. By creating a platform with a surface area that is large enough to cover this average cluster size, bees can easily move within the formation for warmth and food in the space provided. The openings on the side of the platform allow excess heat and moisture within the air to escape to the large open cavity of the enclosing structure.

Accumulated condensation on the inner cover and walls cannot drop on and wet the bees. The platform therefore allows individuals to access fondant at the through hole as needed while keeping them warm and dry. If cardboard packaging is used to cover the fondant, this material will soak up excess moisture, further reducing chance of wetting within the hive. The overall health of the hive is therefore strengthened through this device and method.

Because the platform shields the bee cluster, the beekeeper can easily remove the inner and outer covers at any time with minimal disturbance to the hive to determine whether more food is required. The enclosing structure surrounding the fondant allows for the placement of a large quantity of food at the start of the winter season rather than frequent feedings of small quantities as used in the mountain camp method. Subsequently, the beekeeper does not have to open the inner cover as often to check the food status. If more food is needed, fondant may be added quickly to the top of the feed board, limiting exposure and heat loss. This constant source of food gives the hive confidence to raise broods resulting in more bees in the spring.

This device and method offer financial benefits as well. The low cost and availability of fondant allows beekeepers to harvest and sell more honey than would normally be taken each season. In Pennsylvania for instance, beekeepers tend to leave seventy to one hundred pounds of honey within the hive to increase the bees' chance of survival over the winter. The present method and device allows an equivalent mass of fondant to be used instead. The price of honey currently ranges from $6 per pound to $11 per pound while fondant can be purchased from $0.10 per pound to $0.60 per pound. The hive is therefore significantly more profitable when using this device and method.

### BRIEF DESCRIPTION OF THE DRAWINGS

FIG. 1 is an exploded perspective view showing the standard components of a beehive using the common mountain camp method of feeding;

FIG. 2 is an exploded perspective view of a beehive wherein the present invention is placed atop the frames within the hive tower and the fondant has been shown to the side to illustrate the placement of the through hole;

FIG. 3A is a perspective view of the platform placed on top of a set of frames in a hive box;

FIG. 3B is a side view of a hive box with a platform placed on the frames and further having a container of fondant placed on said platform;

FIG. 4 is an exploded perspective view of the present invention illustrating fondant on the platform stored within its scored cardboard packaging and surrounded by the enclosing structure.

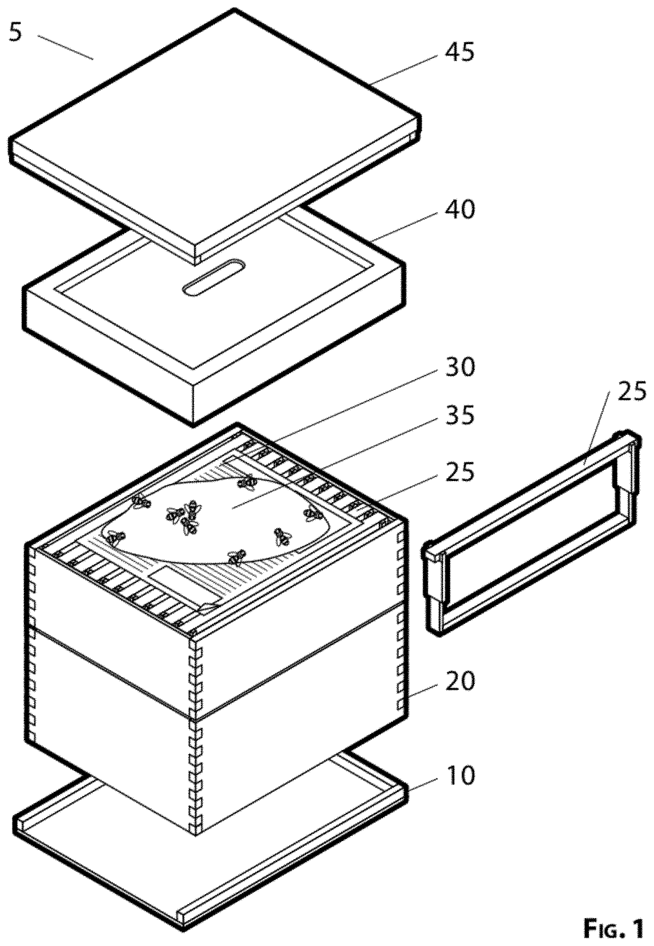

### REFERENCE DESIGNATIONS

5 Standard beehive configuration/Hive Tower
10 Bottom Board
20 Hive Box, Super, or Deep Hive Body
25 Frame
30 Paper
35 Sugar/Fondant
40 Inner Cover
45 Outer Cover
55 Raised Platform
60 Horizontal Face of Raised Platform
65 Elevating Elements/Feet/Supporting Structures
70 Through Hole/Void
75 Mesh
80 Enclosing Structure
85 Cardboard Packaging
90 Bee Cluster
S Spacing Around the Platform
D Diameter of the Through Hole or Breadth of Void where Through Hole is Non-circular
H Platform Height

### DETAILED DESCRIPTION OF THE INVENTION

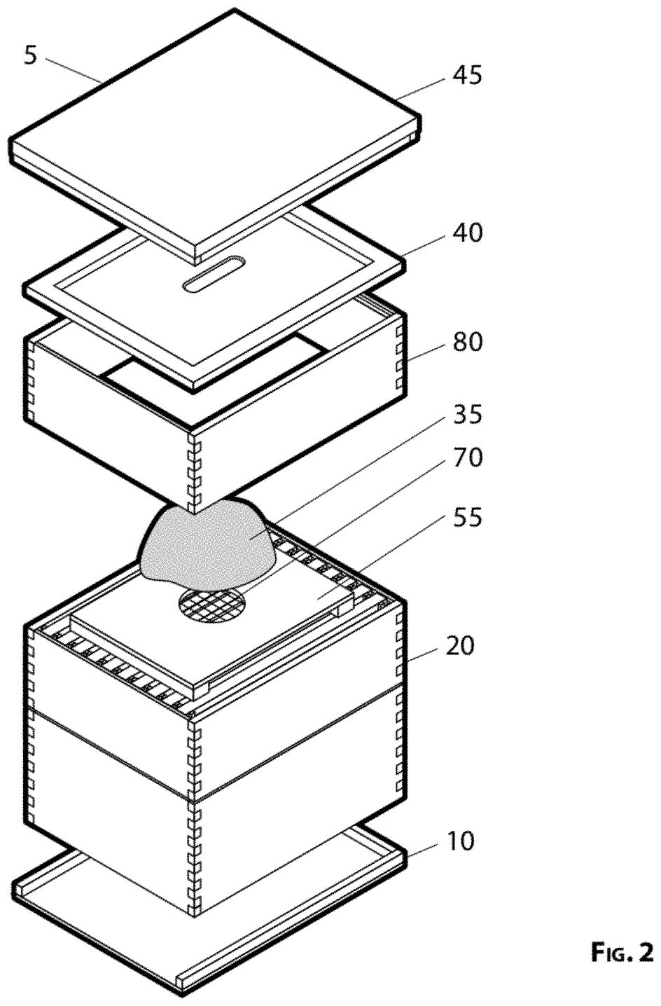

FIG. 2 illustrates the preferred embodiment of a winter beehive configuration wherein the raised platform 55 is substantially centered on the frames 25 set within the uppermost box 20 or super on the hive tower 5. The raised platform 55 is supported by two or more elevating elements, feet, or supporting structures (hereinafter “feet”) 65 such that the horizontal face 60 of the platform 55 remains substantially level. Inventor contemplates the use of two feet 65 that extend the length of two opposing sides of the raised platform 55 as illustrated in FIGS. 2, 3A, 3B and 4. This configuration creates a chamber beneath the raised platform 55 and provides insulation and shelter from air currents on two sides of the feeding area and a ventilation means on the remaining sides of that area. It should be recognized that two or more feet 65 or similar support means may be configured to raise the horizontal feed board 60 and create the required platform height H and chamber beneath the horizontal face 60. These feet 65 may, but need not, extend the entire length of a side of the raised platform 55.

The raised platform 55 has a through hole or void 70 that extends through the full depth of the horizontal face 60 as depicted in FIG. 2, 3A, and 3B. Fondant 35 is placed over this void 70 and is supported by the remaining surface of the horizontal face 60 of the raised platform 55 or mesh 75 as described more fully below. While the ideal diameter (D) (or breadth, where the void is non-circular) is approximately three inches, this distance D may range from at least 1½ inches to a maximum of 6 inches. Any distance D less than 1½ inches will not provide a large enough surface area for the bees to feed. A distance D larger than 6 inches may result in sagging fondant 35 during warmer temperatures and may drip onto the bee cluster 90.

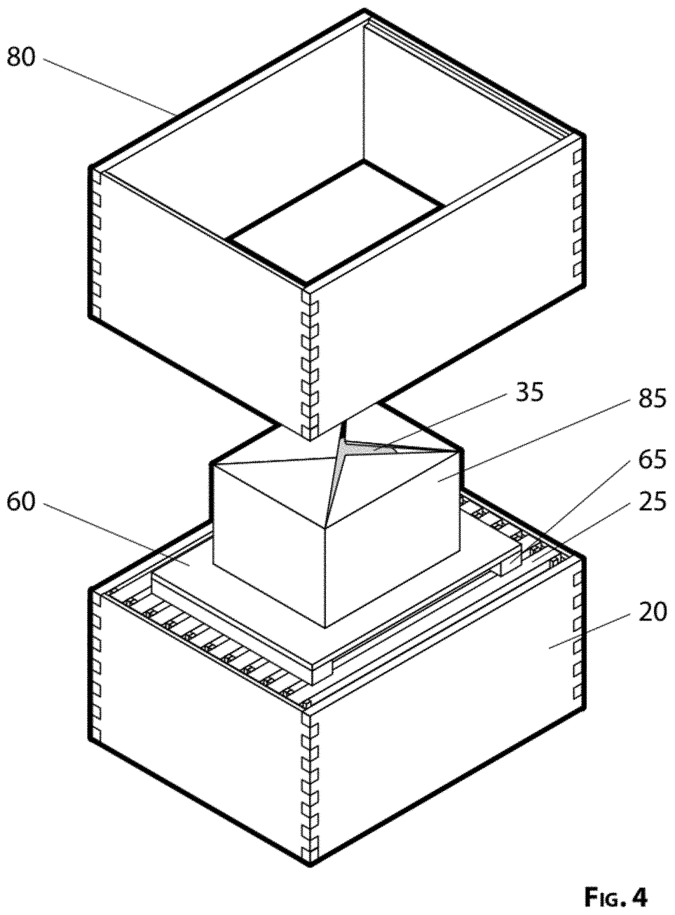

An enclosing structure 80 is securely stacked on the box 20 beneath it, surrounding the raised platform 55 as shown in FIGS. 2 and 4. This enclosing structure 80 provides the depth required to enclose the fondant 35 within the hive tower 5. The enclosing structure 80 should be of a depth that can accommodate the height of the desired amount of fondant 35 being placed on the raised platform 55. Inventor contemplates the use of a standard open-ended deep hive body as shown in FIG. 2; however, any enclosing structure 80 may be used, provided that it is of a size and shape that is consistent with those boxes 20 stacked beneath it. A standard open-ended deep hive body is approximately 9⅝ inches deep and can accommodate one half of a standard carton of fondant 35. It should be recognized that a deeper enclosing structure 80 may be constructed to house a larger quantity of fondant 35 if desired.

Fondant 35 sitting within the enclosing structure 80 may be kept in its original plastic covering in order to prevent desiccation of the feed. Heat and moisture generated by the hive keeps the exposed surface of the fondant 35 moist and of a consistency that is easy for the bees to feed on. Excess heat and moisture escapes through the open area beneath the raised platform 55 where it rises and condenses on the walls of the enclosing structure 80 and inner cover 40. While some humidity will escape the hive tower 5 through the standard notched openings on the inner cover 40, the cardboard packaging 85 may be placed on top of the fondant 35 to absorb additional moisture, if desired. Any condensation dripping off the underside of the inner cover 40 will fall on and be absorbed by this cardboard packaging 85. The top of the cardboard packaging 85 may also be scored as shown in FIG. 4, such that it can be easily opened to view the level of fondant 35 inside. This minimizes disturbance to the cluster 90 and heat loss within the hive.

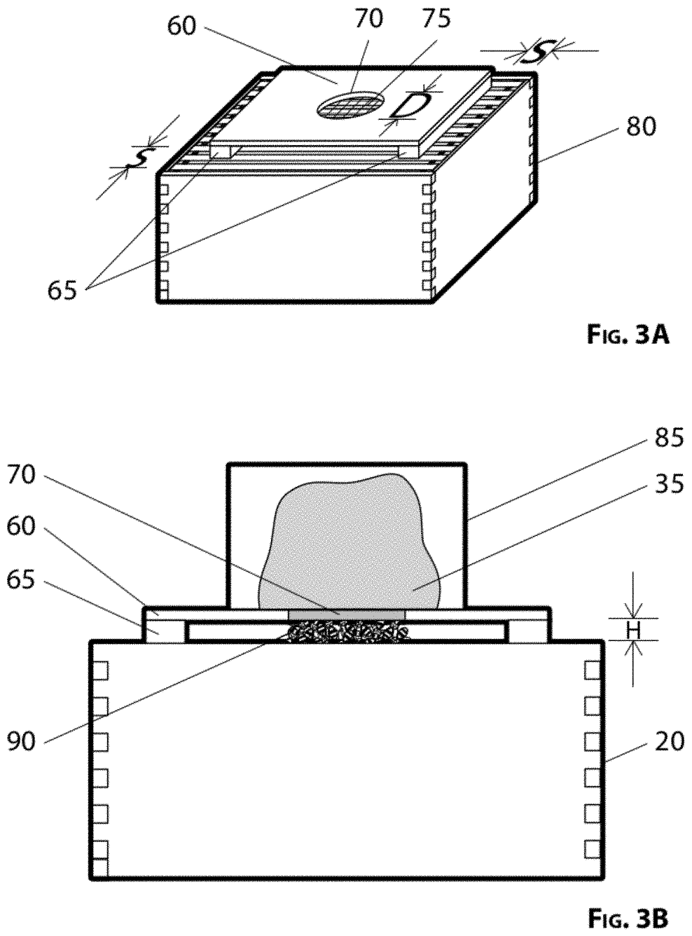

Ideally, the feet 65 are sized such that the horizontal face 60 of the raised platform 55 is positioned at a platform height H of approximately % of an inch above the top of the frames 25 as shown in FIG. 3B. This platform height H can range from approximately ¼ inch to 2 inches. This range gives the bees sufficient space to cluster and feed while preventing condensation buildup beneath the raised platform 55 which may drip and wet the bees beneath. A height H greater than 2 inches may encourage the bees to construct combs which may impede access to the fondant 35.

Referring again to FIGS. 2, 3A, and 3B, the void 70 may be optionally fitted with a mesh 75, hardware cloth, or similar material that can support weight of any fondant 35 having a surface area at its base that is less than that of the void 70. This material is also helpful in preventing the fondant 35 from sagging into the space beneath the raised platform 55 when temperatures increase. The mesh 75 or similar material must be of a size that allows the bees to pass through it to access the fondant 35 above.

The surface area of the horizontal face 60 must be large enough to accommodate the desired quantity of fondant 35 and should distribute the weight of that fondant 35 across the frames 25 in the box 20 beneath it to avoid warpage of those supporting frames 25. While the raised platform 55 should be configured to evenly distribute the weight of the fondant 35 across the frames 25, the frames 25 should not be entirely covered by the raised platform 55.

As previously discussed, heat and condensation within the hive structure rises and collects on the uppermost inner surfaces and walls of the hive tower 5. In standard hive construction. this moisture often drips on the bees, lowering their core temperature and killing them. By leaving a portion of the frames 25 uncovered, the heat and condensation within the frames 25 can escape around the raised platform 55 where it will rise and collect on the walls of the enclosing structure 80 and the inner cover 40 now positioned well above the fondant 35. Because the fondant 35 covers the void 70 and because the bees cluster for warmth and food beneath the surface area of the raised platform 55, the colony is protected from any dripping moisture above. The raised platform 55 therefore provides the appropriate depth for clustering and sheltering while simultaneously offering access to the fondant 35. This method and device therefore provides the cluster 90 with consistent access to food and warmth while solving the “wet bee” issue.

The raised platform 55 is placed such that the feet 65 are oriented substantially ninety degrees from the parallel placement of the frames 25 as shown in FIGS. 2, 3A, 3B and 4; however, it should be recognized that the raised platform 55 may be placed on the frames in any position. If the feet 65 are placed parallel to the frames 25 such that only a few frames bear the weight of the raised platform 55 and fondant 35, the uneven distribution of weight may cause flexing or warpage of those frames 25 carrying the load.

Referring again to FIGS. 2, 3A, and 3B, the surface area of the horizontal face 60 will ideally range from 37-80% of the surface area of the box 20 beneath it. This range provides sufficient surface area for heat and moisture within the frames 25 to escape through the spaced areas S while still providing sufficient surface area to shelter an average sized winter cluster 90. Referring to FIG. 3A, the raised platform 55 is preferably centered on the frame 25 tops such that the spacing S surrounding the platform 55 is substantially uniform; however, as noted above, the raised platform 55 may be placed in any position on the frames 25 and may take any shape provided that the enclosing structure 80 fully encloses the raised platform 55 and fondant 35. The inner cover 40 and outer cover 45 help to seal the hive tower 5.

Standard ten frame beehive boxes (commonly known as Langstroth boxes) have interior dimensions that are generally 18⅜ inches long by 14¾ inches wide. For standard ten frame beehive boxes, the inventor contemplates the use of a rectangular raised platform 55 that is a nominal 16 inches long by a nominal 13 inches wide. This size and shape provides the preferred surface area and weight distribution to support the fondant 35; however, non-rectangular shapes may also be used. It should be noted that other frame configurations and sizes are commonly used, such as 8 frame and 5 frame beehive boxes. As previously noted, the surface area of the horizontal face 60 will ideally range from 37-80% of the surface area of the top of the box 20 holding the frames 25 regardless of the specific hive tower size and frame configuration used.

The feet 65, horizontal face 60 of the raised platform 55, and enclosing structure 80 may be made of wood, plastic or any similarly suitable material. The mesh 75 may be constructed from metal, plastic, fabric, wood or any appropriately durable material.

While the above description contains many specifics, these should be considered exemplifications of one or more embodiments rather than limitations on the scope of the invention. As previously discussed, many variations are possible and the scope of the invention should not be restricted by the examples illustrated herein.

1. A fondant feeding device for beekeeping, the device comprising:
a raised platform comprising a horizontal face having a thickness, the raised platform further comprising elevating elements that project substantially away from said horizontal face thereby creating a chamber beneath said horizontal face having a height that accommodates the movement and formation of a bee cluster; and
at least one through hole penetrating the thickness of the horizontal face;
wherein said raised platform is placed on top of the uppermost beehive box and enclosed within a hive tower; and
wherein the raised platform and the at least one through hole are capable of supporting a quantity of fondant.

2. The device of claim 1 further comprising a mesh that covers, or forms an integral part of, the at least one through hole, wherein the mesh is sized such that it is large enough to allow a bee to access the fondant but small enough to maintain the strength required to support the weight of said fondant.

3. The device of claim 1, wherein the at least one through hole is substantially centered on the horizontal face of the raised platform.

4. The device of claim 1, wherein said elevating elements project substantially away from the horizontal face of the raised platform in a manner that allows heat and moisture to escape the chamber.

5. The device of claim 1, wherein the horizontal face of the raised platform covers between 37 to 80 percent of the surface area of the beehive box immediately beneath it.

6. The device of claim 1, wherein the chamber ranges from a nominal 0.25-2 inches in height.

7. The device of claim 1, wherein the at least one through hole ranges from a nominal 1.5-6 inches in breadth.

8. A method for fondant feeding bees, the method comprising:
Placing a raised platform having at least on through hole on the uppermost beehive box of a hive tower;
Placing a desired quantity of fondant on the raised platform, wherein said fondant is substantially centered on the at least one through hole;
Placing and enclosing structure around the raised platform;
Placing an inner cover above the enclosing structure; and
Placing an outer cover above the inner cover to enclose the fondant and raised platform within the hive tower.

9. The method of claim 8, wherein a mesh material covers or forms an integral part of the at least one through hole.

10. The method of claim 8, wherein the fondant is left in its original packaging such that only fondant in direct contact with the horizontals face is exposed to air.
